(19) United States
(12) Patent Application Publication
(10) Pub. No.: US 2023/0152102 A1
(43) Pub. Date: May 18, 2023

(54) BUILDING MANAGEMENT SYSTEM WITH INDOOR NAVIGATION FEATURES

(71) Applicant: Johnson Controls Tyco IP Holdings LLP, Milwaukee, WI (US)

(72) Inventors: Santle Camilus Kulandai Samy, Sunnyvale, CA (US); Young M. Lee, Old Westbury, NY (US)

(21) Appl. No.: 17/987,498

(22) Filed: Nov. 15, 2022

Related U.S. Application Data
(60) Provisional application No. 63/279,253, filed on Nov. 15, 2021.

(51) Int. Cl. G01C 21/20; G06T 7/70; G06T 11/00

(52) U.S. Cl. CPC G01C 21/206; G06T 7/70; G06T 11/00

(57) ABSTRACT

The present disclosure relates to a building management system (BMS) with indoor navigation features. The BMS comprises a processing circuit and a database. The database comprises a building model, an entity model and spatial anchors. The processing circuit receives camera-derived data from an electronic device associated with a user. Further, a current location of the user within a building is determined by comparing the camera-derived data with the building model. Additionally, a target location may be determined using the entity model. Further, one or more spatial anchors between the target location and the current location are identified to determine a shortest navigable path between the current location and the target location. Subsequently, the spatial anchors are interconnected and provided to the electronic device, wherein the user associated with the electronic device navigates towards the target location by following the interconnected spatial anchors.

### CROSS-REFERENCE TO RELATED APPLICATIONS

This Application claims the benefit of U.S. Provisional Pat. Application No. 63/279,253, filed Nov. 15, 2021, the entirety of which is hereby incorporated by reference herein.

### BACKGROUND

The present disclosure relates generally to building management systems. Particularly, the present disclosure relates to a building management system with indoor navigation features.

A building management system (BMS) is, in general, a system of devices configured to control, monitor, and manage equipment in or around a building or building area. A BMS can include a heating, ventilation, or air conditioning (HVAC) system, a security system, a lighting system, a fire alerting system, another system that is capable of managing building functions or devices, or any combination thereof. BMS devices may be installed in any environment (e.g., an indoor area or an outdoor area) and the environment may include any number of buildings, spaces, zones, rooms, or areas. A BMS may include METASYS® building controllers or other devices sold by Johnson Controls, Inc., as well as building devices and components from other sources.

Generally, building personnel such as operators, service engineers, technicians, etc. are required to locate building points for performing various tasks such as inspections, operations, repairing, servicing, maintenance etc. Building personnel typically require special trainings to locate the building points. In addition, locating building points in large buildings having crowded control rooms is challenging, time consuming and reduces productivity of the building personnel.

Conventional BMS are dependent on various technologies for providing navigation features to locate building points such as GPS, Wi-Fi, Radio, Infrared, Beacons etc. However, the technologies used by the conventional BMS pose various challenges in accurately locating the building points. For example, GPS signals are not available in some parts of large buildings. Some BMS using Wi-Fi technology fail to provide room level accuracy. Radio technologies are prone to false positives. In addition, beacons are battery powered and maintenance of beacons is inconvenient.

There is, therefore, felt a need to provide a Building Management System with indoor navigation features that alleviate the aforementioned drawbacks of the conventional building management systems by accurately locating building points and displaying a navigation path to the building points.

### SUMMARY

One implementation of the present disclosure relates to a building management system (BMS), comprising a processing circuit and a database. The database comprises a building model, an entity model and a plurality of spatial anchors. The processing circuit is configured to receive camera-derived data from an electronic device associated with a user. Further, a current location of the user within a building is determined by comparing the camera-derived data with the building model. Additionally, a target location may be determined using the entity model. Further, one or more spatial anchors between the target location and the current location are identified to determine a shortest navigable path between the current location and the target location. In some embodiments, the spatial anchors are interconnected and provided to the electronic device, wherein the user associated with the electronic device navigates towards the target location by following the interconnected spatial anchors.

In some embodiments, the building management system includes a database including a building model having a plurality of markers, wherein each marker represents an indoor location, an entity model having a plurality of entities and location of each entity, and a plurality of spatial anchors, wherein each spatial anchor is associated with a marker. In some embodiments of the building management system, the processing circuit is configured to identify the current location of the user by comparing the camera-derived data with the building model. In some embodiments of the building management system, the target location corresponds to a location of an entity stored within the entity model.

In some embodiments of the building management system, the processing circuit is configured to identify two or more markers between the current location and the target location, determine a distance between the two or more markers using the building model, select markers representing the shortest navigable path based on the distance, and retrieve spatial anchors associated with the markers representing the shortest navigable path. In some embodiments of the building management system, the processing circuit is configured to interconnect the spatial anchors associated with the markers representing the shortest navigable path and provide the interconnected spatial anchors to the electronic device, wherein the user associated with the electronic device navigates towards the target location by following the interconnected spatial anchors.

Another implementation of the present disclosure relates to a method for providing indoor navigation. The method may include steps that include: receiving camera-derived data from an electronic device associated with a user; determining a current location of the user within a building based on the camera-derived data; and identifying one or more spatial anchors between a target location and the current location of the user to determine a shortest navigable path. In some embodiments, the spatial anchors are interconnected and provided to the electronic device, wherein the user associated with the electronic device navigates towards the target location by following the interconnected spatial anchors. The method may be performed by a processing circuit.

Another implementation of the present disclosure relates to a building management system (BMS) including one or more non-transitory computer-readable storage media storing instructions that, when executed by one or more processors, cause the one or more processors to perform operations. The operations include receiving a target location from an electronic device associated with a user, determining, a current location of the user within a building, determining a shortest navigable path from the current location to the target location, and identifying one or more spatial anchors associated with the shortest navigable path. In some embodiments, the operations further include providing information regarding the one or more identified spatial anchors to the electronic device to guide the user from the current location to the target location. In some embodiments, the one or more non-transitory computer-readable storage media include a database including a list of spatial anchors including the one or more identified spatial anchors, and a building model having a plurality of markers, wherein each marker represents an indoor location associated with one of the one or more spatial anchors. In some embodiments, the operations further include identifying the current location of the user by comparing the camera-derived data with the building model. In some embodiments, the database further includes an entity model having a plurality of entities and a location of each entity. In some embodiments, the target location corresponds to a location of one of the plurality of entities. In some embodiments, determining the shortest navigable path from the current location to the target location includes determining a distance between each of one or more pairs of markers using the building model determining the shortest navigable path based on the one or more determined distances, a retrieving spatial anchors associated with markers representing the shortest navigable path. In some embodiments, the operations further include interconnecting the spatial anchors associated with the markers representing the shortest navigable path, receiving, from the electronic device, a video feed from a camera associated with the electronic device, generating a combined video feed including a graphical representation of the shortest navigable path superimposed on the video feed from the camera, and providing the combined video feed to the electronic device. In some embodiments, the graphical representation of the shortest navigable path includes a visible navigation path connecting the spatial anchors associated with the markers representing the shortest navigable path. In some embodiments, the operations further include receiving an indication of one or more obstacles, determining and tagging one or more markers associated with spatial anchors proximate the one or more obstacles, and excluding the one or more tagged markers from the determination of the shortest navigable path. In some embodiments the current location of the user is determined based on camera-derived data. The camera-derive data may be received from a camera of the electronic device or one or more other cameras. In some embodiments, the operations further include interconnecting the spatial anchors associated with the markers representing the shortest navigable path, receiving, from the electronic device, a video feed from a camera associated with the electronic device, generating a graphical representation of the shortest navigable path based on the video feed from the camera, and providing the graphical representation to the electronic device for display on a transparent surface, wherein the graphical representation is superimposed on a real-world view that is visible through the transparent surface.

Another implementation of the present disclosure relates to a method for determining a path in a building. The method includes receiving a video feed of the building from an electronic device associated with a user, comparing depth data from the video feed with stored depth data from a building model associated with the building, determining a current location of the user within the building based on the comparison, receiving a target location within the building from the electronic device, and determining a path from the current location to the target location by identifying and connecting one or more markers representing an indoor location of the building. In some embodiments, the one or more markers each correspond to a spatial anchor located in the building. In some embodiments, the method includes identifying, in the video feed, the spatial anchors corresponding to the one or more markers, generating a combined video feed including a graphical representation of the path superimposed on the video feed from the electronic device, the graphical representation of the path connecting the identified spatial anchors in the video feed, and providing the combined video feed to the electronic device. In some embodiments, the method include receiving an indication of an obstacle in the building, determining one or more spatial anchors proximate the obstacle, and tagging one or more markers associated with the one or more spatial anchors proximate the obstacle, wherein the determined path avoids the tagged markers. In some embodiments, the path is one of a shortest navigable path or an alternate navigational path determined based on a user selection received from the electronic device.

Another implementation of the present disclosure relates to one or more non-transitory computer-readable storage media storing instructions that, when executed by one or more processors, cause the one or more processors to perform operations. The operations include receiving a desired destination from an electronic device associated with a user, receiving a video feed from the electronic device, determining, based on the video feed, a current location of the user within a building, determining a shortest navigable path from the current location to the desired destination, and identifying a plurality of spatial anchors that can be connected to form the shortest navigable path. In some embodiments, determining a shortest navigable path from the current location to the desired destination includes querying a database of markers, wherein each marker is associated with a location of one of the spatial anchors, determining a distance between each of one or more pairs of markers, and determining the shortest navigable path based on the one or more determined distances. In some embodiments, the operations further include receiving an indication of one or more obstacles, determining and tagging one or more markers associated with spatial anchors proximate the one or more obstacles, and determining a shortest navigable path that does not include the tagged markers. In some embodiments, the operations further include detecting spatial anchors in the video feed, generating a combined video feed including a graphical representation of the shortest navigable path superimposed on the video feed from the electronic device, wherein the graphical representation of the shortest navigable path connects two or more of the detected spatial anchors, and providing the combined video feed to the electronic device. In some embodiments, the graphical representation indicates the location of the desired destination, wherein the desired destination is not visible in the video feed.

### BRIEF DESCRIPTION OF THE DRAWINGS

Various objects, aspects, features, and advantages of the disclosure will become more apparent and better understood by referring to the detailed description taken in conjunction with the accompanying drawings, in which like reference characters identify corresponding elements throughout. In the drawings, like reference numbers generally indicate identical, functionally similar, and/or structurally similar elements.

FIG. 1 is a drawing of a building equipped with a building management system (BMS), according to some embodiments.

FIG. 2 is a block diagram of a BMS that serves the building of FIG. 1, according to some embodiments.

FIG. 3 is a block diagram of a BMS controller which can be used in the BMS of FIG. 2, according to some embodiments.

FIG. 4 is another block diagram of the BMS that serves the building of FIG. 1, according to some embodiments.

FIG. 5 is a block diagram of a computing system that can be used in the BMS, according to some embodiments.

FIG. 6 is a diagram illustrating an entity model of FIG. 5, according to some embodiments.

FIG. 7 is another diagram of the entity model of FIG. 5, according to some embodiments.

FIG. 8 is a snapshot of a navigation path determined by the computing system of FIG. 5, according to some embodiments.

FIG. 9 is another snapshot of the navigation path determined by the computing system of FIG. 5, according to some embodiments.

FIG. 10 is a flowchart of a method for indoor navigation, according to some embodiments.

FIG. 11 is a flowchart of a method for indoor navigation, according to some embodiments.

FIG. 12 is a flowchart of a method for indoor navigation, according to some embodiments.

### DETAILED DESCRIPTION

Before turning to the Figures, it should be understood that the disclosure is not limited to the details or methodology set forth in the description or illustrated in the figures. It should also be understood that the terminology is for the purpose of description only and should not be regarded as limiting.

Referring generally to the Figures, a computing system is shown and described. The computing system may be utilized in conjunction with a plurality of building automation or management systems, subsystems, or as a part high level building automation system. For example, the computing system may be a part of a Johnson Controls Facility Explorer system.

The present disclosure describes systems and methods that address the shortcomings of conventional systems. As referred in the background, indoor navigation in buildings for locating building points is challenging and time consuming. Building personnel require special trainings to locate the building points for performing one or more operations. Additionally, technologies used by conventional BMS fail to accurately locate the building points.

The present disclosure overcomes the shortcomings of the conventional BMS by providing a BMS with indoor navigation features that can accurately locate the building points and display a hologram of a shortest navigable path to the building points based on mixed reality techniques.

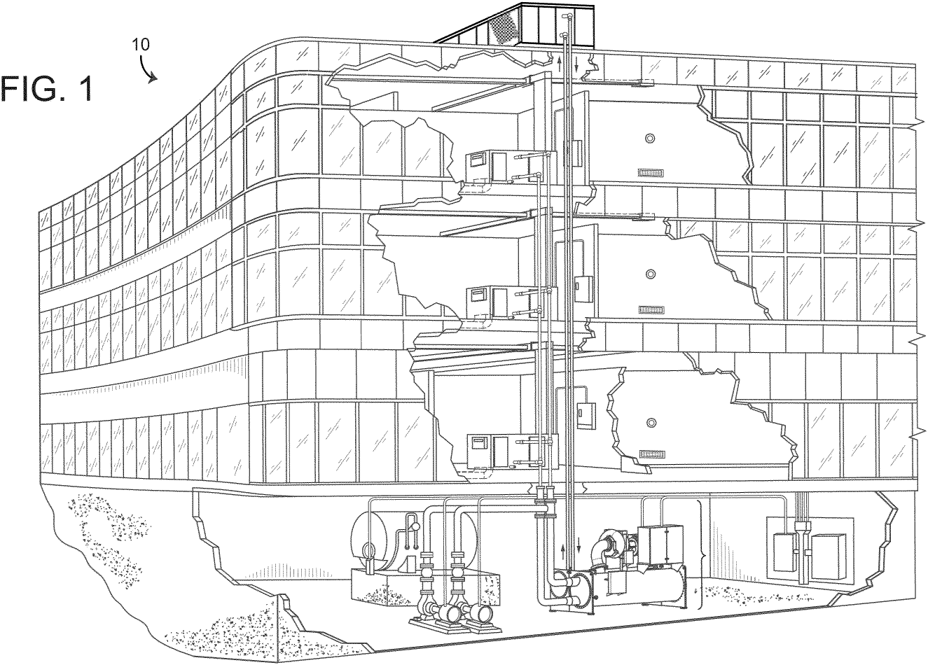

Referring now to FIG. 1, a perspective view of a building 10 is shown, according to an exemplary embodiment. A BMS serves building 10. The BMS for building 10 may include any number or type of devices that serve building 10. For example, each floor may include one or more security devices, video surveillance cameras, fire detectors, smoke detectors, lighting systems, HVAC systems, or other building systems or devices. In modern BMSs, BMS devices can exist on different networks within the building (e.g., one or more wireless networks, one or more wired networks, etc.) and yet serve the same building space or control loop. For example, BMS devices may be connected to different communications networks or field controllers even if the devices serve the same area (e.g., floor, conference room, building zone, tenant area, etc.) or purpose (e.g., security, ventilation, cooling, heating, etc.).

BMS devices may collectively or individually be referred to as building equipment. Building equipment may include any number or type of BMS devices within or around building 10. For example, building equipment may include controllers, chillers, rooftop units, fire and security systems, elevator systems, thermostats, lighting, serviceable equipment (e.g., vending machines), and/or any other type of equipment that can be used to control, automate, or otherwise contribute to an environment, state, or condition of building 10. The terms “BMS devices,” “BMS device” and “building equipment” are used interchangeably throughout this disclosure.

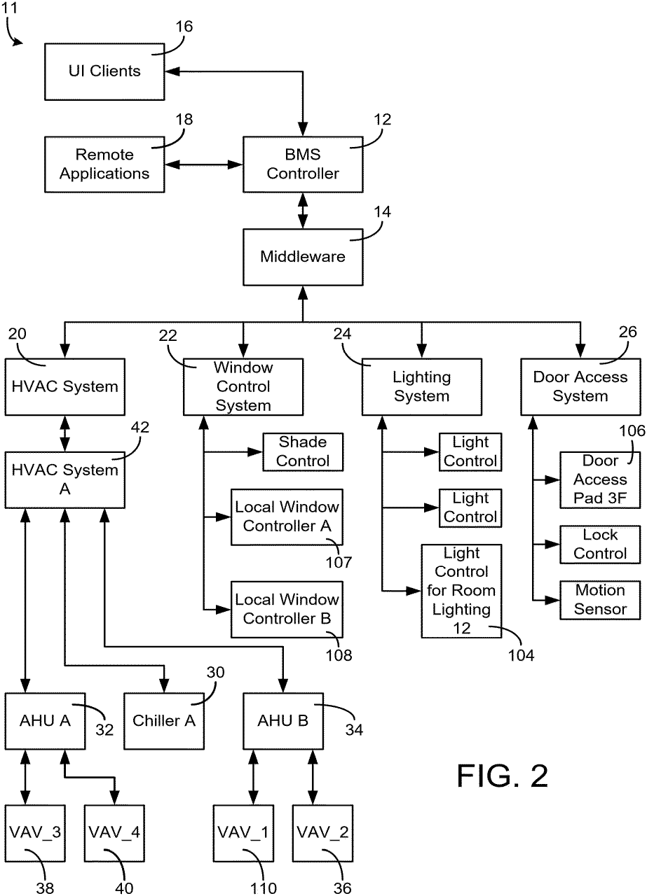

Referring now to FIG. 2, a block diagram of a BMS 11 for building 10 is shown, according to an exemplary embodiment. BMS 11 is shown to include a plurality of BMS subsystems 20-26. Each BMS subsystem 20-26 is connected to a plurality of BMS devices and makes data points for varying connected devices available to upstream BMS controller 12. Additionally, BMS subsystems 20-26 may encompass other lower-level subsystems. For example, an HVAC system may be broken down further as “HVAC system A,” “HVAC system B,” etc. In some buildings, multiple HVAC systems or subsystems may exist in parallel and may not be a part of the same HVAC system 20.

As shown in FIG. 2, BMS 11 may include a HVAC system 20. HVAC system 20 may control HVAC operations building 10. HVAC system 20 is shown to include a lower-level HVAC system 42 (named “HVAC system A”). HVAC system 42 may control HVAC operations for a specific floor or zone of building 10. HVAC system 42 may be connected to air handling units (AHUs) 32, 34 (named “AHU A” and “AHU B,” respectively, in BMS 11). AHU 32 may serve variable air volume (VAV) boxes 38, 40 (named “VAV_3” and “VAV_4” in BMS 11). Likewise, AHU 34 may serve VAV boxes 36 and 110 (named “VAV_2” and “VAV_1”). HVAC system 42 may also include chiller 30 (named “Chiller A” in BMS 11). Chiller 30 may provide chilled fluid to AHU 32 and/or to AHU 34. HVAC system 42 may receive data (i.e., BMS inputs such as temperature sensor readings, damper positions, temperature setpoints, etc.) from AHUs 32, 34. HVAC system 42 may provide such BMS inputs to HVAC system 20 and on to middleware 14 and BMS controller 12. Similarly, other BMS subsystems may receive inputs from other building devices or objects and provide the received inputs to BMS controller 12 (e.g., via middleware 14).

Middleware 14 may include services that allow interoperable communication to, from, or between disparate BMS subsystems 20-26 of BMS 11 (e.g., HVAC systems from different manufacturers, HVAC systems that communicate according to different protocols, security/fire systems, IT resources, door access systems, etc.). Middleware 14 may be, for example, an EnNet server sold by Johnson Controls, Inc. While middleware 14 is shown as separate from BMS controller 12, middleware 14 and BMS controller 12 may integrated in some embodiments. For example, middleware 14 may be a part of BMS controller 12.

Still referring to FIG. 2, window control system 22 may receive shade control information from one or more shade controls, ambient light level information from one or more light sensors, and/or other BMS inputs (e.g., sensor information, setpoint information, current state information, etc.) from downstream devices. Window control system 22 may include window controllers 107, 108 (e.g., named “local window controller A” and “local window controller B,” respectively, in BMS 11). Window controllers 107, 108 control the operation of subsets of window control system 22. For example, window controller 108 may control window blind or shade operations for a given room, floor, or building in the BMS.

Lighting system 24 may receive lighting related information from a plurality of downstream light controls (e.g., from room lighting 104). Door access system 26 may receive lock control, motion, state, or other door related information from a plurality of downstream door controls. Door access system 26 is shown to include door access pad 106 (named “Door Access Pad 3F”), which may grant or deny access to a building space (e.g., a floor, a conference room, an office, etc.) based on whether valid user credentials are scanned or entered (e.g., via a keypad, via a badge-scanning pad, etc.).

BMS subsystems 20-26 may be connected to BMS controller 12 via middleware 14 and may be configured to provide BMS controller 12 with BMS inputs from various BMS subsystems 20-26 and their varying downstream devices. BMS controller 12 may be configured to make differences in building subsystems transparent at the human-machine interface or client interface level (e.g., for connected or hosted user interface (UI) clients 16, remote applications 18, etc.). BMS controller 12 may be configured to describe or model different building devices and building subsystems using common or unified objects (e.g., software objects stored in memory) to help provide the transparency. Software equipment objects may allow developers to write applications capable of monitoring and/or controlling various types of building equipment regardless of equipment-specific variations (e.g., equipment model, equipment manufacturer, equipment version, etc.). Software building objects may allow developers to write applications capable of monitoring and/or controlling building zones on a zone-by-zone level regardless of the building subsystem makeup.

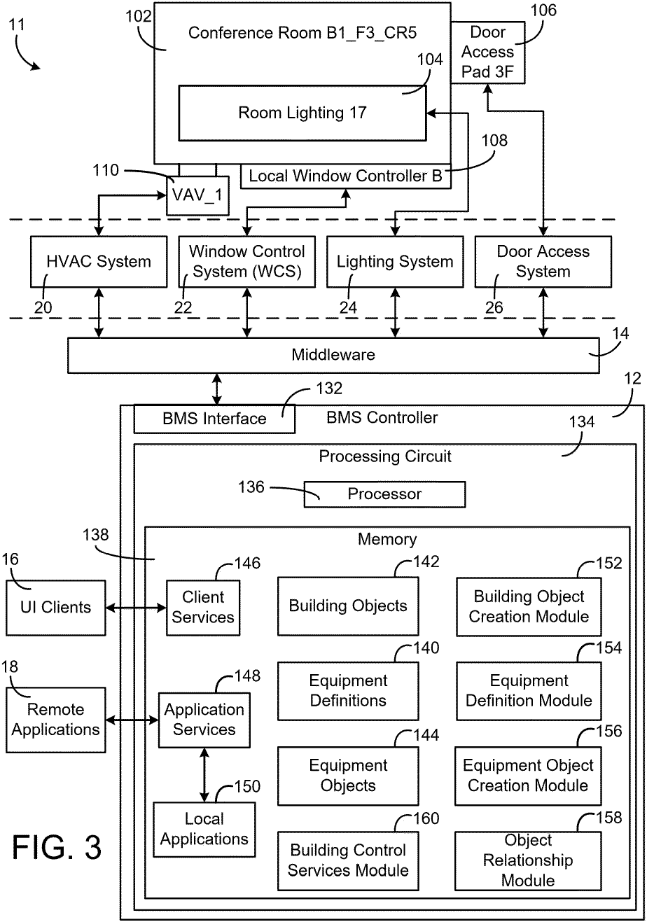

Referring now to FIG. 3, a block diagram illustrating a portion of BMS 11 in greater detail is shown, according to an exemplary embodiment. Particularly, FIG. 3 illustrates a portion of BMS 11 that services a conference room 102 of building 10 (named “B1_F3_CRS”). Conference room 102 may be affected by many different building devices connected to many different BMS subsystems. For example, conference room 102 includes or is otherwise affected by VAV box 110, window controller 108 (e.g., a blind controller), a system of lights 104 (named “Room Lighting 17”), and a door access pad 106.

Each of the building devices shown at the top of FIG. 3 may include local control circuitry configured to provide signals to their supervisory controllers or more generally to the BMS subsystems 20-26. The local control circuitry of the building devices shown at the top of FIG. 3 may also be configured to receive and respond to control signals, commands, setpoints, or other data from their supervisory controllers. For example, the local control circuitry of VAV box 110 may include circuitry that affects an actuator in response to control signals received from a field controller that is a part of HVAC system 20. Window controller 108 may include circuitry that affects windows or blinds in response to control signals received from a field controller that is part of window control system (WCS) 22. Room lighting 104 may include circuitry that affects the lighting in response to control signals received from a field controller that is part of lighting system 24. Access pad 106 may include circuitry that affects door access (e.g., locking or unlocking the door) in response to control signals received from a field controller that is part of door access system 26.

Still referring to FIG. 3, BMS controller 12 is shown to include a BMS interface 132 in communication with middleware 14. In some embodiments, BMS interface 132 is a communications interface. For example, BMS interface 132 may include wired or wireless interfaces (e.g., jacks, antennas, transmitters, receivers, transceivers, wire terminals, etc.) for conducting data communications with various systems, devices, or networks. BMS interface 132 can include an Ethernet card and port for sending and receiving data via an Ethernet-based communications network. In another example, BMS interface 132 includes a Wi-Fi transceiver for communicating via a wireless communications network. BMS interface 132 may be configured to communicate via local area networks or wide area networks (e.g., the Internet, a building WAN, etc.).

In some embodiments, BMS interface 132 and/or middleware 14 includes an application gateway configured to receive input from applications running on client devices. For example, BMS interface 132 and/or middleware 14 may include one or more wireless transceivers (e.g., a Wi-Fi transceiver, a Bluetooth transceiver, an NFC transceiver, a cellular transceiver, etc.) for communicating with client devices. BMS interface 132 may be configured to receive building management inputs from middleware 14 or directly from one or more BMS subsystems 20-26. BMS interface 132 and/or middleware 14 can include any number of software buffers, queues, listeners, filters, translators, or other communications-supporting services.

Still referring to FIG. 3, BMS controller 12 is shown to include a processing circuit 134 including a processor 136 and memory 138. Processor 136 may be a general purpose or specific purpose processor, an application specific integrated circuit (ASIC), one or more field programmable gate arrays (FPGAs), a group of processing components, or other suitable processing components. Processor 136 is configured to execute computer code or instructions stored in memory 138 or received from other computer readable media (e.g., CDROM, network storage, a remote server, etc.).

Memory 138 may include one or more devices (e.g., memory units, memory devices, storage devices, etc.) for storing data and/or computer code for completing and/or facilitating the various processes described in the present disclosure. Memory 138 may include random access memory (RAM), read-only memory (ROM), hard drive storage, temporary storage, non-volatile memory, flash memory, optical memory, or any other suitable memory for storing software objects and/or computer instructions. Memory 138 may include database components, object code components, script components, or any other type of information structure for supporting the various activities and information structures described in the present disclosure. Memory 138 may be communicably connected to processor 136 via processing circuit 134 and may include computer code for executing (e.g., by processor 136) one or more processes described herein. When processor 136 executes instructions stored in memory 138 for completing the various activities described herein, processor 136 generally configures BMS controller 12 (and more particularly processing circuit 134) to complete such activities.

Still referring to FIG. 3, memory 138 is shown to include building objects 142. In some embodiments, BMS controller 12 uses building objects 142 to group otherwise ungrouped or unassociated devices so that the group may be addressed or handled by applications together and in a consistent manner (e.g., a single user interface for controlling all of the BMS devices that affect a particular building zone or room). Building objects can apply to spaces of any granularity. For example, a building object can represent an entire building, a floor of a building, or individual rooms on each floor. In some embodiments, BMS controller 12 creates and/or stores a building object in memory 138 for each zone or room of building 10. Building objects 142 can be accessed by UI clients 16 and remote applications 18 to provide a comprehensive user interface for controlling and/or viewing information for a particular building zone. Building objects 142 may be created by building object creation module 152 and associated with equipment objects by object relationship module 158, described in greater detail below.

Still referring to FIG. 3, memory 138 is shown to include equipment definitions 140. Equipment definitions 140 stores the equipment definitions for various types of building equipment. Each equipment definition may apply to building equipment of a different type. For example, equipment definitions 140 may include different equipment definitions for variable air volume modular assemblies (VMAs), fan coil units, air handling units (AHUs), lighting fixtures, water pumps, and/or other types of building equipment.

Equipment definitions 140 define the types of data points that are generally associated with various types of building equipment. For example, an equipment definition for VMA may specify data point types such as room temperature, damper position, supply air flow, and/or other types data measured or used by the VMA. Equipment definitions 140 allow for the abstraction (e.g., generalization, normalization, broadening, etc.) of equipment data from a specific BMS device so that the equipment data can be applied to a room or space.

Each of equipment definitions 140 may include one or more point definitions. Each point definition may define a data point of a particular type and may include search criteria for automatically discovering and/or identifying data points that satisfy the point definition. An equipment definition can be applied to multiple pieces of building equipment of the same general type (e.g., multiple different VMA controllers). When an equipment definition is applied to a BMS device, the search criteria specified by the point definitions can be used to automatically identify data points provided by the BMS device that satisfy each point definition.

In some embodiments, equipment definitions 140 define data point types as generalized types of data without regard to the model, manufacturer, vendor, or other differences between building equipment of the same general type. The generalized data points defined by equipment definitions 140 allows each equipment definition to be referenced by or applied to multiple different variants of the same type of building equipment.

In some embodiments, equipment definitions 140 facilitate the presentation of data points in a consistent and user-friendly manner. For example, each equipment definition may define one or more data points that are displayed via a user interface. The displayed data points may be a subset of the data points defined by the equipment definition.

In some embodiments, equipment definitions 140 specify a system type (e.g., HVAC, lighting, security, fire, etc.), a system sub-type (e.g., terminal units, air handlers, central plants), and/or data category (e.g., critical, diagnostic, operational) associated with the building equipment defined by each equipment definition. Specifying such attributes of building equipment at the equipment definition level allows the attributes to be applied to the building equipment along with the equipment definition when the building equipment is initially defined. Building equipment can be filtered by various attributes provided in the equipment definition to facilitate the reporting and management of equipment data from multiple building systems.

Equipment definitions 140 can be automatically created by abstracting the data points provided by archetypal controllers (e.g., typical or representative controllers) for various types of building equipment. In some embodiments, equipment definitions 140 are created by equipment definition module 154, described in greater detail below.

Still referring to FIG. 3, memory 138 is shown to include equipment objects 144. Equipment objects 144 may be software objects that define a mapping between a data point type (e.g., supply air temperature, room temperature, damper position) and an actual data point (e.g., a measured or calculated value for the corresponding data point type) for various pieces of building equipment. Equipment objects 144 may facilitate the presentation of equipment-specific data points in an intuitive and user-friendly manner by associating each data point with an attribute identifying the corresponding data point type. The mapping provided by equipment objects 144 may be used to associate a particular data value measured or calculated by BMS 11 with an attribute that can be displayed via a user interface.

Equipment objects 144 can be created (e.g., by equipment object creation module 156) by referencing equipment definitions 140. For example, an equipment object can be created by applying an equipment definition to the data points provided by a BMS device. The search criteria included in an equipment definition can be used to identify data points of the building equipment that satisfy the point definitions. A data point that satisfies a point definition can be mapped to an attribute of the equipment object corresponding to the point definition.

Each equipment object may include one or more attributes defined by the point definitions of the equipment definition used to create the equipment object. For example, an equipment definition which defines the attributes “Occupied Command,” “Room Temperature,” and “Damper Position” may result in an equipment object being created with the same attributes. The search criteria provided by the equipment definition are used to identify and map data points associated with a particular BMS device to the attributes of the equipment object. The creation of equipment objects is described in greater detail below with reference to equipment object creation module 156.

Equipment objects 144 may be related with each other and/or with building objects 142. Causal relationships can be established between equipment objects to link equipment objects to each other. For example, a causal relationship can be established between a VMA and an AHU which provides airflow to the VMA. Causal relationships can also be established between equipment objects 144 and building objects 142. For example, equipment objects 144 can be associated with building objects 142 representing particular rooms or zones to indicate that the equipment object serves that room or zone. Relationships between objects are described in greater detail below with reference to object relationship module 158.

Still referring to FIG. 3, memory 138 is shown to include client services 146 and application services 148. Client services 146 may be configured to facilitate interaction and/or communication between BMS controller 12 and various internal or external clients or applications. For example, client services 146 may include web services or application programming interfaces available for communication by UI clients 16 and remote applications 18 (e.g., applications running on a mobile device, energy monitoring applications, applications allowing a user to monitor the performance of the BMS, automated fault detection and diagnostics systems, etc.). Application services 148 may facilitate direct or indirect communications between remote applications 18, local applications 150, and BMS controller 12. For example, application services 148 may allow BMS controller 12 to communicate (e.g., over a communications network) with remote applications 18 running on mobile devices and/or with other BMS controllers.

In some embodiments, application services 148 facilitate an applications gateway for conducting electronic data communications with UI clients 16 and/or remote applications 18. For example, application services 148 may be configured to receive communications from mobile devices and/or BMS devices. Client services 146 may provide client devices with a graphical user interface that consumes data points and/or display data defined by equipment definitions 140 and mapped by equipment objects 144.

Still referring to FIG. 3, memory 138 is shown to include a building object creation module 152. Building object creation module 152 may be configured to create the building objects stored in building objects 142. Building object creation module 152 may create a software building object for various spaces within building 10. Building object creation module 152 can create a building obj ect for a space of any size or granularity. For example, building object creation module 152 can create a building object representing an entire building, a floor of a building, or individual rooms on each floor. In some embodiments, building object creation module 152 creates and/or stores a building object in memory 138 for each zone or room of building 10.

The building objects created by building object creation module 152 can be accessed by UI clients 16 and remote applications 18 to provide a comprehensive user interface for controlling and/or viewing information for a particular building zone. Building objects 142 can group otherwise ungrouped or unassociated devices so that the group may be addressed or handled by applications together and in a consistent manner (e.g., a single user interface for controlling all of the BMS devices that affect a particular building zone or room). In some embodiments, building object creation module 152 uses the systems and methods described in U.S. Pat. App. No. 12/887,390, filed Sep. 21, 2010, for creating software defined building objects.

In some embodiments, building object creation module 152 provides a user interface for guiding a user through a process of creating building objects. For example, building object creation module 152 may provide a user interface to client devices (e.g., via client services 146) that allows a new space to be defined. In some embodiments, building object creation module 152 defines spaces hierarchically. For example, the user interface for creating building objects may prompt a user to create a space for a building, for floors within the building, and/or for rooms or zones within each floor.

In some embodiments, building object creation module 152 creates building objects automatically or semi-automatically. For example, building object creation module 152 may automatically define and create building objects using data imported from another data source (e.g., user view folders, a table, a spreadsheet, etc.). In some embodiments, building object creation module 152 references an existing hierarchy for BMS 11 to define the spaces within building 10. For example, BMS 11 may provide a listing of controllers for building 10 (e.g., as part of a network of data points) that have the physical location (e.g., room name) of the controller in the name of the controller itself. Building object creation module 152 may extract room names from the names of BMS controllers defined in the network of data points and create building objects for each extracted room. Building objects may be stored in building objects 142.

Still referring to FIG. 3, memory 138 is shown to include an equipment definition module 154. Equipment definition module 154 may be configured to create equipment definitions for various types of building equipment and to store the equipment definitions in equipment definitions 140. In some embodiments, equipment definition module 154 creates equipment definitions by abstracting the data points provided by archetypal controllers (e.g., typical or representative controllers) for various types of building equipment. For example, equipment definition module 154 may receive a user selection of an archetypal controller via a user interface. The archetypal controller may be specified as a user input or selected automatically by equipment definition module 154. In some embodiments, equipment definition module 154 selects an archetypal controller for building equipment associated with a terminal unit such as a VMA.

Equipment definition module 154 may identify one or more data points associated with the archetypal controller. Identifying one or more data points associated with the archetypal controller may include accessing a network of data points provided by BMS 11. The network of data points may be a hierarchical representation of data points that are measured, calculated, or otherwise obtained by various BMS devices. BMS devices may be represented in the network of data points as nodes of the hierarchical representation with associated data points depending from each BMS device. Equipment definition module 154 may find the node corresponding to the archetypal controller in the network of data points and identify one or more data points which depend from the archetypal controller node.

Equipment definition module 154 may generate a point definition for each identified data point of the archetypal controller. Each point definition may include an abstraction of the corresponding data point that is applicable to multiple different controllers for the same type of building equipment. For example, an archetypal controller for a particular VMA (i.e., “VMA-20”) may be associated an equipment-specific data point such as “VMA-20.DPR-POS” (i.e., the damper position of VMA-20) and/or “VMA-20. SUP-FLOW” (i.e., the supply air flow rate through VMA-20). Equipment definition module 154 abstract the equipment-specific data points to generate abstracted data point types that are generally applicable to other equipment of the same type. For example, equipment definition module 154 may abstract the equipment-specific data point “VMA-20.DPR-POS” to generate the abstracted data point type “DPR-POS” and may abstract the equipment-specific data point “VMA-20.SUP-FLOW” to generate the abstracted data point type “SUP-FLOW.” Advantageously, the abstracted data point types generated by equipment definition module 154 can be applied to multiple different variants of the same type of building equipment (e.g., VMAs from different manufacturers, VMAs having different models or output data formats, etc.).

In some embodiments, equipment definition module 154 generates a user-friendly label for each point definition. The user-friendly label may be a plain text description of the variable defined by the point definition. For example, equipment definition module 154 may generate the label “Supply Air Flow” for the point definition corresponding to the abstracted data point type “SUP-FLOW” to indicate that the data point represents a supply air flow rate through the VMA. The labels generated by equipment definition module 154 may be displayed in conjunction with data values from BMS devices as part of a user-friendly interface.

In some embodiments, equipment definition module 154 generates search criteria for each point definition. The search criteria may include one or more parameters for identifying another data point (e.g., a data point associated with another controller of BMS 11 for the same type of building equipment) that represents the same variable as the point definition. Search criteria may include, for example, an instance number of the data point, a network address of the data point, and/or a network point type of the data point.

In some embodiments, search criteria include a text string abstracted from a data point associated with the archetypal controller. For example, equipment definition module 154 may generate the abstracted text string “SUP-FLOW” from the equipment-specific data point “VMA-20.SUP-FLOW.” Advantageously, the abstracted text string matches other equipment-specific data points corresponding to the supply air flow rates of other BMS devices (e.g., “VMA-18.SUP-FLOW,” “SUP-FLOW.VMA-01,” etc.). Equipment definition module 154 may store a name, label, and/or search criteria for each point definition in memory 138.

Equipment definition module 154 may use the generated point definitions to create an equipment definition for a particular type of building equipment (e.g., the same type of building equipment associated with the archetypal controller). The equipment definition may include one or more of the generated point definitions. Each point definition defines a potential attribute of BMS devices of the particular type and provides search criteria for identifying the attribute among other data points provided by such BMS devices.

In some embodiments, the equipment definition created by equipment definition module 154 includes an indication of display data for BMS devices that reference the equipment definition. Display data may define one or more data points of the BMS device that will be displayed via a user interface. In some embodiments, display data are user defined. For example, equipment definition module 154 may prompt a user to select one or more of the point definitions included in the equipment definition to be represented in the display data. Display data may include the user-friendly label (e.g., “Damper Position”) and/or short name (e.g., “DPR-POS”) associated with the selected point definitions.

In some embodiments, equipment definition module 154 provides a visualization of the equipment definition via a graphical user interface. The visualization of the equipment definition may include a point definition portion which displays the generated point definitions, a user input portion configured to receive a user selection of one or more of the point definitions displayed in the point definition portion, and/or a display data portion which includes an indication of an abstracted data point corresponding to each of the point definitions selected via the user input portion. The visualization of the equipment definition can be used to add, remove, or change point definitions and/or display data associated with the equipment definitions.

Equipment definition module 154 may generate an equipment definition for each different type of building equipment in BMS 11 (e.g., VMAs, chillers, AHUs, etc.). Equipment definition module 154 may store the equipment definitions in a data storage device (e.g., memory 138, equipment definitions 140, an external or remote data storage device, etc.).

Still referring to FIG. 3, memory 138 is shown to include an equipment object creation module 156. Equipment object creation module 156 may be configured to create equipment objects for various BMS devices. In some embodiments, equipment object creation module 156 creates an equipment object by applying an equipment definition to the data points provided by a BMS device. For example, equipment object creation module 156 may receive an equipment definition created by equipment definition module 154. Receiving an equipment definition may include loading or retrieving the equipment definition from a data storage device.

In some embodiments, equipment object creation module 156 determines which of a plurality of equipment definitions to retrieve based on the type of BMS device used to create the equipment object. For example, if the BMS device is a VMA, equipment object creation module 156 may retrieve the equipment definition for VMAs; whereas if the BMS device is a chiller, equipment object creation module 156 may retrieve the equipment definition for chillers. The type of BMS device to which an equipment definition applies may be stored as an attribute of the equipment definition. Equipment object creation module 156 may identify the type of BMS device being used to create the equipment object and retrieve the corresponding equipment definition from the data storage device.

In other embodiments, equipment object creation module 156 receives an equipment definition prior to selecting a BMS device. Equipment object creation module 156 may identify a BMS device of BMS 11 to which the equipment definition applies. For example, equipment object creation module 156 may identify a BMS device that is of the same type of building equipment as the archetypal BMS device used to generate the equipment definition. In various embodiments, the BMS device used to generate the equipment object may be selected automatically (e.g., by equipment object creation module 156), manually (e.g., by a user) or semi-automatically (e.g., by a user in response to an automated prompt from equipment object creation module 156).

In some embodiments, equipment object creation module 156 creates an equipment discovery table based on the equipment definition. For example, equipment object creation module 156 may create an equipment discovery table having attributes (e.g., columns) corresponding to the variables defined by the equipment definition (e.g., a damper position attribute, a supply air flow rate attribute, etc.). Each column of the equipment discovery table may correspond to a point definition of the equipment definition. The equipment discovery table may have columns that are categorically defined (e.g., representing defined variables) but not yet mapped to any particular data points.

Equipment object creation module 156 may use the equipment definition to automatically identify one or more data points of the selected BMS device to map to the columns of the equipment discovery table. Equipment object creation module 156 may search for data points of the BMS device that satisfy one or more of the point definitions included in the equipment definition. In some embodiments, equipment object creation module 156 extracts a search criterion from each point definition of the equipment definition. Equipment object creation module 156 may access a data point network of the building automation system to identify one or more data points associated with the selected BMS device. Equipment object creation module 156 may use the extracted search criterion to determine which of the identified data points satisfy one or more of the point definitions.

In some embodiments, equipment object creation module 156 automatically maps (e.g., links, associates, relates, etc.) the identified data points of selected BMS device to the equipment discovery table. A data point of the selected BMS device may be mapped to a column of the equipment discovery table in response to a determination by equipment object creation module 156 that the data point satisfies the point definition (e.g., the search criteria) used to generate the column. For example, if a data point of the selected BMS device has the name “VMA-18. SUP-FLOW” and a search criterion is the text string “SUP-FLOW,” equipment object creation module 156 may determine that the search criterion is met. Accordingly, equipment object creation module 156 may map the data point of the selected BMS device to the corresponding column of the equipment discovery table.

Advantageously, equipment object creation module 156 may create multiple equipment objects and map data points to attributes of the created equipment objects in an automated fashion (e.g., without human intervention, with minimal human intervention, etc.). The search criteria provided by the equipment definition facilitates the automatic discovery and identification of data points for a plurality of equipment object attributes. Equipment object creation module 156 may label each attribute of the created equipment objects with a device-independent label derived from the equipment definition used to create the equipment object. The equipment objects created by equipment object creation module 156 can be viewed (e.g., via a user interface) and/or interpreted by data consumers in a consistent and intuitive manner regardless of device-specific differences between BMS devices of the same general type. The equipment objects created by equipment object creation module 156 may be stored in equipment objects 144.

Still referring to FIG. 3, memory 138 is shown to include an object relationship module 158. Object relationship module 158 may be configured to establish relationships between equipment objects 144. In some embodiments, object relationship module 158 establishes causal relationships between equipment objects 144 based on the ability of one BMS device to affect another BMS device. For example, object relationship module 158 may establish a causal relationship between a terminal unit (e.g., a VMA) and an upstream unit (e.g., an AHU, a chiller, etc.) which affects an input provided to the terminal unit (e.g., air flow rate, air temperature, etc.).

Object relationship module 158 may establish relationships between equipment objects 144 and building objects 142 (e.g., spaces). For example, object relationship module 158 may associate equipment objects 144 with building objects 142 representing particular rooms or zones to indicate that the equipment object serves that room or zone. In some embodiments, object relationship module 158 provides a user interface through which a user can define relationships between equipment objects 144 and building objects 142. For example, a user can assign relationships in a “drag and drop” fashion by dragging and dropping a building object and/or an equipment object into a “serving” cell of an equipment object provided via the user interface to indicate that the BMS device represented by the equipment object serves a particular space or BMS device.

Still referring to FIG. 3, memory 138 is shown to include a building control services module 160. Building control services module 160 may be configured to automatically control BMS 11 and the various subsystems thereof. Building control services module 160 may utilize closed loop control, feedback control, PI control, model predictive control, or any other type of automated building control methodology to control the environment (e.g., a variable state or condition) within building 10.

Building control services module 160 may receive inputs from sensory devices (e.g., temperature sensors, pressure sensors, flow rate sensors, humidity sensors, electric current sensors, cameras, radio frequency sensors, microphones, etc.), user input devices (e.g., computer terminals, client devices, user devices, etc.) or other data input devices via BMS interface 132. Building control services module 160 may apply the various inputs to a building energy use model and/or a control algorithm to determine an output for one or more building control devices (e.g., dampers, air handling units, chillers, boilers, fans, pumps, etc.) in order to affect a variable state or condition within building 10 (e.g., zone temperature, humidity, air flow rate, etc.).

In some embodiments, building control services module 160 is configured to control the environment of building 10 on a zone-individualized level. For example, building control services module 160 may control the environment of two or more different building zones using different setpoints, different constraints, different control methodology, and/or different control parameters. Building control services module 160 may operate BMS 11 to maintain building conditions (e.g., temperature, humidity, air quality, etc.) within a setpoint range, to optimize energy performance (e.g., to minimize energy consumption, to minimize energy cost, etc.), and/or to satisfy any constraint or combination of constraints as may be desirable for various implementations.

In some embodiments, building control services module 160 uses the location of various BMS devices to translate an input received from a building system into an output or control signal for the building system. Building control services module 160 may receive location information for BMS devices and automatically set or recommend control parameters for the BMS devices based on the locations of the BMS devices. For example, building control services module 160 may automatically set a flow rate setpoint for a VAV box based on the size of the building zone in which the VAV box is located.

Building control services module 160 may determine which of a plurality of sensors to use in conjunction with a feedback control loop based on the locations of the sensors within building 10. For example, building control services module 160 may use a signal from a temperature sensor located in a building zone as a feedback signal for controlling the temperature of the building zone in which the temperature sensor is located.

In some embodiments, building control services module 160 automatically generates control algorithms for a controller or a building zone based on the location of the zone in the building 10. For example, building control services module 160 may be configured to predict a change in demand resulting from sunlight entering through windows based on the orientation of the building and the locations of the building zones (e.g., east-facing, west-facing, perimeter zones, interior zones, etc.).

Building control services module 160 may use zone location information and interactions between adjacent building zones (rather than considering each zone as an isolated system) to more efficiently control the temperature and/or airflow within building 10. For control loops that are conducted at a larger scale (i.e., floor level) building control services module 160 may use the location of each building zone and/or BMS device to coordinate control functionality between building zones. For example, building control services module 160 may consider heat exchange and/or air exchange between adjacent building zones as a factor in determining an output control signal for the building zones.

In some embodiments, building control services module 160 is configured to optimize the energy efficiency of building 10 using the locations of various BMS devices and the control parameters associated therewith. Building control services module 160 may be configured to achieve control setpoints using building equipment with a relatively lower energy cost (e.g., by causing airflow between connected building zones) in order to reduce the loading on building equipment with a relatively higher energy cost (e.g., chillers and roof top units). For example, building control services module 160 may be configured to move warmer air from higher elevation zones to lower elevation zones by establishing pressure gradients between connected building zones.

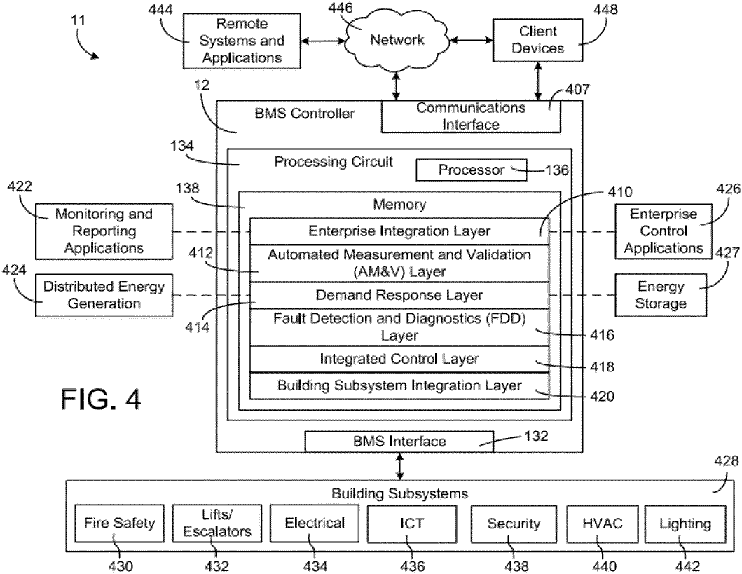

Referring now to FIG. 4, another block diagram illustrating a portion of BMS 11 in greater detail is shown, according to some embodiments. BMS 11 can be implemented in building 10 to automatically monitor and control various building functions. BMS 11 is shown to include BMS controller 12 and a plurality of building subsystems 428. Building subsystems 428 are shown to include a building electrical subsystem 434, an information communication technology (ICT) subsystem 436, a security subsystem 438, a HVAC subsystem 440, a lighting subsystem 442, a lift/escalators subsystem 432, and a fire safety subsystem 430. In various embodiments, building subsystems 428 can include fewer, additional, or alternative subsystems. For example, building subsystems 428 may also or alternatively include a refrigeration subsystem, an advertising or signage subsystem, a cooking subsystem, a vending subsystem, a printer or copy service subsystem, or any other type of building subsystem that uses controllable equipment and/or sensors to monitor or control building 10.

Each of building subsystems 428 can include any number of devices, controllers, and connections for completing its individual functions and control activities. HVAC subsystem 440 can include many of the same components as HVAC system 20, as described with reference to FIGS. 2-3. For example, HVAC subsystem 440 can include a chiller, a boiler, any number of air handling units, economizers, field controllers, supervisory controllers, actuators, temperature sensors, and other devices for controlling the temperature, humidity, airflow, or other variable conditions within building 10. Lighting subsystem 442 can include any number of light fixtures, ballasts, lighting sensors, dimmers, or other devices configured to controllably adjust the amount of light provided to a building space. Security subsystem 438 can include occupancy sensors, video surveillance cameras, digital video recorders, video processing servers, intrusion detection devices, access control devices and servers, or other security-related devices.

Still referring to FIG. 4, BMS controller 12 is shown to include a communications interface 407 and a BMS interface 132. Interface 407 may facilitate communications between BMS controller 12 and external applications (e.g., monitoring and reporting applications 422, enterprise control applications 426, remote systems and applications 444, applications residing on client devices 448, etc.) for allowing user control, monitoring, and adjustment to BMS controller 12 and/or subsystems 428. Interface 407 may also facilitate communications between BMS controller 12 and client devices 448. BMS interface 132 may facilitate communications between BMS controller 12 and building subsystems 428 (e.g., HVAC, lighting security, lifts, power distribution, business, etc.).

Interfaces 407, 132 can be or include wired or wireless communications interfaces (e.g., jacks, antennas, transmitters, receivers, transceivers, wire terminals, etc.) for conducting data communications with building subsystems 428 or other external systems or devices. In various embodiments, communications via interfaces 407, 132 can be direct (e.g., local wired or wireless communications) or via a communications network 446 (e.g., a WAN, the Internet, a cellular network, etc.). For example, interfaces 407, 132 can include an Ethernet card and port for sending and receiving data via an Ethernet-based communications link or network. In another example, interfaces 407, 132 can include a Wi-Fi transceiver for communicating via a wireless communications network. In another example, one or both of interfaces 407, 132 can include cellular or mobile phone communications transceivers. In one embodiment, communications interface 407 is a power line communications interface and BMS interface 132 is an Ethernet interface. In other embodiments, both communications interface 407 and BMS interface 132 are Ethernet interfaces or are the same Ethernet interface.

Still referring to FIG. 4, BMS controller 12 is shown to include a processing circuit 134 including a processor 136 and memory 138. Processing circuit 134 can be communicably connected to BMS interface 132 and/or communications interface 407 such that processing circuit 134 and the various components thereof can send and receive data via interfaces 407, 132. Processor 136 can be implemented as a general purpose processor, an application specific integrated circuit (ASIC), one or more field programmable gate arrays (FPGAs), a group of processing components, or other suitable electronic processing components.

Memory 138 (e.g., memory, memory unit, storage device, etc.) can include one or more devices (e.g., RAM, ROM, Flash memory, hard disk storage, etc.) for storing data and/or computer code for completing or facilitating the various processes, layers and modules described in the present application. Memory 138 can be or include volatile memory or non-volatile memory. Memory 138 can include database components, object code components, script components, or any other type of information structure for supporting the various activities and information structures described in the present application. According to some embodiments, memory 138 is communicably connected to processor 136 via processing circuit 134 and includes computer code for executing (e.g., by processing circuit 134 and/or processor 136) one or more processes described herein.

In some embodiments, BMS controller 12 is implemented within a single computer (e.g., one server, one housing, etc.). In various other embodiments BMS controller 12 can be distributed across multiple servers or computers (e.g., that can exist in distributed locations). Further, while FIG. 4 shows applications 422 and 426 as existing outside of BMS controller 12, in some embodiments, applications 422 and 426 can be hosted within BMS controller 12 (e.g., within memory 138).

Still referring to FIG. 4, memory 138 is shown to include an enterprise integration layer 410, an automated measurement and validation (AM&V) layer 412, a demand response (DR) layer 414, a fault detection and diagnostics (FDD) layer 416, an integrated control layer 418, and a building subsystem integration later 420. Layers 410-420 can be configured to receive inputs from building subsystems 428 and other data sources, determine optimal control actions for building subsystems 428 based on the inputs, generate control signals based on the optimal control actions, and provide the generated control signals to building subsystems 428. The following paragraphs describe some of the general functions performed by each of layers 410-420 in BMS 11.

Enterprise integration layer 410 can be configured to serve clients or local applications with information and services to support a variety of enterprise-level applications. For example, enterprise control applications 426 can be configured to provide subsystem-spanning control to a graphical user interface (GUI) or to any number of enterprise-level business applications (e.g., accounting systems, user identification systems, etc.). Enterprise control applications 426 may also or alternatively be configured to provide configuration GUIs for configuring BMS controller 12. In yet other embodiments, enterprise control applications 426 can work with layers 410-420 to optimize building performance (e.g., efficiency, energy use, comfort, or safety) based on inputs received at interface 407 and/or BMS interface 132.

Building subsystem integration layer 420 can be configured to manage communications between BMS controller 12 and building subsystems 428. For example, building subsystem integration layer 420 may receive sensor data and input signals from building subsystems 428 and provide output data and control signals to building subsystems 428. Building subsystem integration layer 420 may also be configured to manage communications between building subsystems 428. Building subsystem integration layer 420 translate communications (e.g., sensor data, input signals, output signals, etc.) across a plurality of multi-vendor/multi-protocol systems.

Demand response layer 414 can be configured to optimize resource usage (e.g., electricity use, natural gas use, water use, etc.) and/or the monetary cost of such resource usage in response to satisfy the demand of building 10. The optimization can be based on time-of-use prices, curtailment signals, energy availability, or other data received from utility providers, distributed energy generation systems 424, from energy storage 427, or from other sources. Demand response layer 414 may receive inputs from other layers of BMS controller 12 (e.g., building subsystem integration layer 420, integrated control layer 418, etc.). The inputs received from other layers can include environmental or sensor inputs such as temperature, carbon dioxide levels, relative humidity levels, air quality sensor outputs, occupancy sensor outputs, room schedules, and the like. The inputs may also include inputs such as electrical use (e.g., expressed in kWh), thermal load measurements, pricing information, projected pricing, smoothed pricing, curtailment signals from utilities, and the like.

According to some embodiments, demand response layer 414 includes control logic for responding to the data and signals it receives. These responses can include communicating with the control algorithms in integrated control layer 418, changing control strategies, changing setpoints, or activating/deactivating building equipment or subsystems in a controlled manner. Demand response layer 414 may also include control logic configured to determine when to utilize stored energy. For example, demand response layer 414 may determine to begin using energy from energy storage 427 just prior to the beginning of a peak use hour.

In some embodiments, demand response layer 414 includes a control module configured to actively initiate control actions (e.g., automatically changing setpoints) which minimize energy costs based on one or more inputs representative of or based on demand (e.g., price, a curtailment signal, a demand level, etc.). In some embodiments, demand response layer 414 uses equipment models to determine an optimal set of control actions. The equipment models can include, for example, thermodynamic models describing the inputs, outputs, and/or functions performed by various sets of building equipment. Equipment models may represent collections of building equipment (e.g., subplants, chiller arrays, etc.) or individual devices (e.g., individual chillers, heaters, pumps, etc.).

Demand response layer 414 may further include or draw upon one or more demand response policy definitions (e.g., databases, XML files, etc.). The policy definitions can be edited or adjusted by a user (e.g., via a graphical user interface) so that the control actions initiated in response to demand inputs can be tailored for the user’s application, desired comfort level, particular building equipment, or based on other concerns. For example, the demand response policy definitions can specify which equipment can be turned on or off in response to particular demand inputs, how long a system or piece of equipment should be turned off, what setpoints can be changed, what the allowable set point adjustment range is, how long to hold a high demand setpoint before returning to a normally scheduled setpoint, how close to approach capacity limits, which equipment modes to utilize, the energy transfer rates (e.g., the maximum rate, an alarm rate, other rate boundary information, etc.) into and out of energy storage devices (e.g., thermal storage tanks, battery banks, etc.), and when to dispatch on-site generation of energy (e.g., via fuel cells, a motor generator set, etc.).

Integrated control layer 418 can be configured to use the data input or output of building subsystem integration layer 420 and/or demand response later 414 to make control decisions. Due to the subsystem integration provided by building subsystem integration layer 420, integrated control layer 418 can integrate control activities of the subsystems 428 such that the subsystems 428 behave as a single integrated supersystem. In some embodiments, integrated control layer 418 includes control logic that uses inputs and outputs from a plurality of building subsystems to provide greater comfort and energy savings relative to the comfort and energy savings that separate subsystems could provide alone. For example, integrated control layer 418 can be configured to use an input from a first subsystem to make an energy-saving control decision for a second subsystem. Results of these decisions can be communicated back to building subsystem integration layer 420.

Integrated control layer 418 is shown to be logically below demand response layer 414. Integrated control layer 418 can be configured to enhance the effectiveness of demand response layer 414 by enabling building subsystems 428 and their respective control loops to be controlled in coordination with demand response layer 414. This configuration may advantageously reduce disruptive demand response behavior relative to conventional systems. For example, integrated control layer 418 can be configured to assure that a demand response-driven upward adjustment to the setpoint for chilled water temperature (or another component that directly or indirectly affects temperature) does not result in an increase in fan energy (or other energy used to cool a space) that would result in greater total building energy use than was saved at the chiller.

Integrated control layer 418 can be configured to provide feedback to demand response layer 414 so that demand response layer 414 checks that constraints (e.g., temperature, lighting levels, etc.) are properly maintained even while demanded load shedding is in progress. The constraints may also include setpoint or sensed boundaries relating to safety, equipment operating limits and performance, comfort, fire codes, electrical codes, energy codes, and the like. Integrated control layer 418 is also logically below fault detection and diagnostics layer 416 and automated measurement and validation layer 412. Integrated control layer 418 can be configured to provide calculated inputs (e.g., aggregations) to these higher levels based on outputs from more than one building subsystem.

Automated measurement and validation (AM&V) layer 412 can be configured to verify that control strategies commanded by integrated control layer 418 or demand response layer 414 are working properly (e.g., using data aggregated by AM&V layer 412, integrated control layer 418, building subsystem integration layer 420, FDD layer 416, or otherwise). The calculations made by AM&V layer 412 can be based on building system energy models and/or equipment models for individual BMS devices or subsystems. For example, AM&V layer 412 may compare a model-predicted output with an actual output from building subsystems 428 to determine an accuracy of the model.

Fault detection and diagnostics (FDD) layer 416 can be configured to provide on-going fault detection for building subsystems 428, building subsystem devices (i.e., building equipment), and control algorithms used by demand response layer 414 and integrated control layer 418. FDD layer 416 may receive data inputs from integrated control layer 418, directly from one or more building subsystems or devices, or from another data source. FDD layer 416 may automatically diagnose and respond to detected faults. The responses to detected or diagnosed faults can include providing an alert message to a user, a maintenance scheduling system, or a control algorithm configured to attempt to repair the fault or to work-around the fault.

FDD layer 416 can be configured to output a specific identification of the faulty component or cause of the fault (e.g., loose damper linkage) using detailed subsystem inputs available at building subsystem integration layer 420. In other exemplary embodiments, FDD layer 416 is configured to provide “fault” events to integrated control layer 418 which executes control strategies and policies in response to the received fault events. According to some embodiments, FDD layer 416 (or a policy executed by an integrated control engine or business rules engine) may shut-down systems or direct control activities around faulty devices or systems to reduce energy waste, extend equipment life, or assure proper control response.

FDD layer 416 can be configured to store or access a variety of different system data stores (or data points for live data). FDD layer 416 may use some content of the data stores to identify faults at the equipment level (e.g., specific chiller, specific AHU, specific terminal unit, etc.) and other content to identify faults at component or subsystem levels. For example, building subsystems 428 may generate temporal (i.e., time-series) data indicating the performance of BMS 11 and the various components thereof. The data generated by building subsystems 428 can include measured or calculated values that exhibit statistical characteristics and provide information about how the corresponding system or process (e.g., a temperature control process, a flow control process, etc.) is performing in terms of error from its setpoint. These processes can be examined by FDD layer 416 to expose when the system begins to degrade in performance and alert a user to repair the fault before it becomes more severe.

### Indoor Navigation

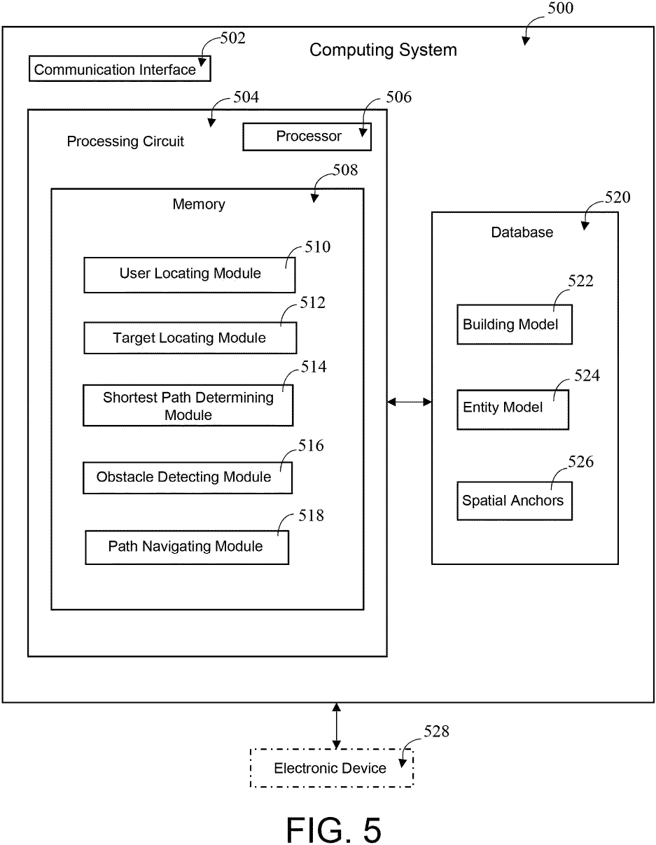

Referring now to FIG. 5, a block diagram illustrating a computing system 500 is shown, according to some embodiments. Computing system 500 can be a controller of the building management systems (BMS) described above with respect to FIGS. 1-4. In some embodiments, the computing system 500 can be implemented in one or more edge devices of the BMS for enhanced security. Computing system 500 is shown to include a communication interface 502, a processing circuit 504 and a database 520. Communication interface 502 may include wired or wireless interfaces (e.g., jacks, antennas, transmitters, receivers, transceivers, wire terminals, etc.) for conducting data communications with various systems, devices, or networks. For example, communication interface 502 may include an Ethernet card and port for sending and receiving data via an Ethernet-based communications network and/or a Wi-Fi transceiver for communicating via a wireless communications network. Communication interface 502 may be configured to communicate via local area networks or wide area networks (e.g., the Internet, a building WAN, etc.) and may use a variety of communication protocols (e.g., BACnet, IP, LON, etc.).

Communication interface 502 may be a network interface configured to facilitate electronic data communications between the computing system 500 and various external systems or devices (e.g., one or more user interfaces). In some embodiments, the communication interface 502 can be the communication interface of the building management systems (BMS) described above with respect to FIGS. 1-4. In some embodiments, the user interface may be associated with an electronic device of a user (e.g., electronic device 528).

The processing circuit 504 is shown to include a processor 506 and a memory 508. In some embodiments, the processing circuit 504 can be the processing circuit of the building management systems (BMS) described above with respect to FIGS. 1-4. The processor 506 may be a general purpose or specific purpose processor, an application specific integrated circuit (ASIC), one or more field programmable gate arrays (FPGAs), a group of processing components, or other suitable processing components. The processor 506 may be configured to execute computer code or instructions stored in memory 508 or received from other computer readable media (e.g., CDROM, network storage, a remote server, etc.).

The memory 508 may include one or more devices (e.g., memory units, memory devices, storage devices, etc.) for storing data and/or computer code for completing and/or facilitating the various processes described in the present disclosure. The memory 508 may include random access memory (RAM), read-only memory (ROM), hard drive storage, temporary storage, non-volatile memory, flash memory, optical memory, or any other suitable memory for storing software objects and/or computer instructions. The memory 508 may include database components, object code components, script components, or any other type of information structure for supporting various activities and information structures described in the present disclosure. The memory 508 may be communicably connected to the processor 506 via the processing circuit 504 and may include computer code for executing (e.g., by processor 506) one or more processes described herein.

In some embodiments, the computing system 500 may be facilitated with one or more modes of operation such as an admin mode and a user mode. The admin mode may be provided for facility managers for configuring the computing system 500. The user mode may be provided for users such as an operator, a technician, a service engineer etc. that are required to locate building points for performing various tasks such as inspections, operations, repairing, servicing, maintenance etc.

Still referring to FIG. 5, the computing system 500 comprises the database 520 that is shown to include a building model 522. In some embodiments, the building model 522 may be obtained based on Building Information Modeling (BIM). BIM is a process involving generation and management of digital representations of physical and functional characteristics of a building. In the BIM, a building and its equipment are represented via electronic maps such as 2D maps, 3D maps etc. BIM may generate 3D building models that provide information on various aspects of the building such as floorplan, locations of objects (like building points, building equipment, lights, furniture, doors, windows, stairs, elevators etc.), depth information for objects etc.

In some other embodiments, the building model 522 may be obtained based on 2D floor map and further a pseudo 3D building model may be constructed from the 2D floor map. The pseudo 3D building model may be analyzed to generate the building model 522. Additionally, a combination of one or more 3D building models may be used for generating the building model 522.

Further, in some other embodiments, the building model 522 may be obtained by generating a 3D pathway map based on scene depth information received from an electronic device (for example, the electronic device 528) during the admin mode.

In some embodiments, the building model 522 may store a plurality of markers. Each marker created in the building model 522 may represent an indoor location of the building.

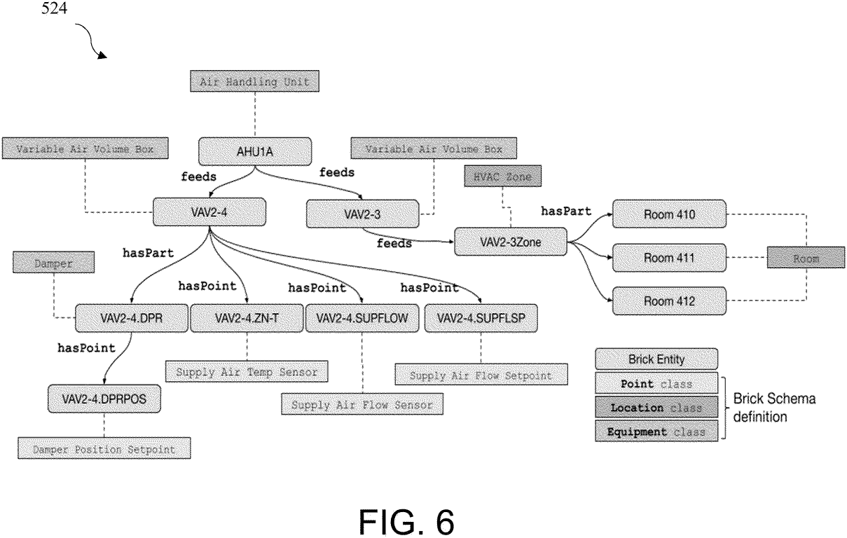

Further, the database 520 is shown to include an entity model 524. The entity model 524 may store a plurality of entities and location details of each entity. In some embodiments, the entity model 524 may be alternatively referred as a brick model or a brick schema. The brick model (shown in FIG. 6) may represent one or more entities such as building equipment, building points etc. The brick model may provide semantic descriptions of the one or more entities and relationship between the one or more entities.

Further, the database 520 is shown to include spatial anchors 526. The spatial anchors 526 may comprise information about one or more spatial anchors such as location of the one or more spatial anchors, depth of the one or more spatial anchors etc. In some embodiments, during the admin mode, the spatial anchors 526 may be placed in the building such that a walkable path is provided between two adjacent spatial anchors from the one or more spatial anchors. In some embodiments, the spatial anchors 526 may be placed at prime locations, for example, at an entrance point and an exit point of a building, floors, rooms etc. In some embodiments, the spatial anchors 526 may be placed at walkway ends or corners of a building. Further, each spatial anchor may be associated with a marker such that a one-on-one correspondence is established between the spatial anchors 526 and the markers.

Still referring to FIG. 5, the computing system 500 is shown to be in communication with the electronic device 528, typically, via the communication interface 502. In some embodiments, the electronic device 528 can be one of, but not limited to, mobile, smartphone, smartwatch, laptop, personal digital assistant (PDA), tablet, head mounted display (HMD) unit, head mounted video glasses, head up display (HUD), or any other mixed reality device. The electronic device 528 may be associated with the user that is required to locate building points for performing various tasks such as inspections, operations, repairing, servicing, maintenance etc.

The electronic device 528 may include a camera to generate a camera-derived view of surroundings of the electronic device 528, while the user is maneuvering the electronic device 528 within the building. The electronic device 528 may generate a camera-derived data that is further provided to the computing system 500. In some embodiments, the electronic device 528 may include an application or software facilitating mixed reality functionality in the electronic device 528 for enabling the electronic device 528 to display a hologram of a navigation path superimposed over the camera-derived view in real-time. In some embodiments, the electronic device 528 may include a transparent surface, which the user may look through to see a real-world view, rather than a camera-derived view reproduced on a display screen. For example, the electronic device 528 may be or may include a head mounted display unit, head mounted video glasses, or any other mixed reality device. The electronic device 528 may be enabled to display information or images on the transparent surface as a head-up display while enabling the user to look through the transparent surface to the real-world. The hologram or other graphical representation of the navigation path can be displayed on the transparent surface, giving the appearance of the navigation path superimposed on the real world. In some embodiments, the electronic device 528 may include a projector configured to project a graphical representation of the navigation path onto the floor or wall of the building. The hologram or graphic representation of the navigation path may be positioned on the display of the camera-derived view, the transparent surface, or a floor or wall via projection based on spatial anchors detected in the video feed from the electronic device 528. The computing system 500 may determine, based on the detected spatial anchors in the video feed, the proper orientation of the navigation path such that the hologram or graphical representation is accurately superimposed on the real-world view or the display of the camera-derived view or projected on to a floor or wall.

In some embodiments, the computing system 500 may receive a navigation request from the electronic device 528 associated with the user. The navigation request may be generated for obtaining a navigation path to a target location in a building. In some embodiments, the user may generate the navigation request to the electronic device 528 through text based search queries, voice commands, gestures etc.

Still referring to FIG. 5, the computing system 500 is shown to include a user locating module 510. The user locating module 510 may be configured to determine a current location of the user within a building in response to the navigation request received from the electronic device 528. The user locating module 510 may utilize the camera-derived data that is received from the electronic device 528 (during the user mode). The camera-derived data may provide the scene depth information of surroundings of the electronic device 528. The scene depth information may indicate depth between one or more objects such as walls in the building.

Further, the user locating module 510 may co-operate with the database 520 to utilize the building model 522 for determining the current location of the user equipped with the electronic device 528. Subsequently, the user locating module 510 may compare the scene depth information obtained from the camera-derived data with the building model 522. For example, a relative depth between one or more objects such as walls in the building may be compared in the camera-derived data with respect to the building model 522. The current location of the user may be determined based on the comparison of the relative depth. In some embodiments, other camera-derived data may be used to determine the location of the user. The building may include cameras, such as security cameras, that can detect the current location of the user and/or the electronic device 528 using, for example, image processing. For example a first security camera and a second security camera may detect the user simultaneously. By comparing the apparent size of the user within the camera frame, the distance of the user from each camera can be determined, and thereby the location of the user can be determined. In some embodiments, the location of the user may be determined based on processing circuits contained within the electronic device 528 that are connected to a wireless receiver. For example, the electronic device may include a GPS receiver, a Wi-Fi receiver, a cellular receiver, or any other wireless communication receiver, and the processing circuit may determine, based on signals received from the wireless receiver, the location of the device. The user device 528 can then deliver the location to the computing system 500. In some embodiments, the user device 528 may send information from the wireless receiver to the computing system 500, and the computing system 500 may determine the location of the electronic device 528.

Still, referring to FIG. 5, the computing system 500 is shown to include a target locating module 512. The target locating module 512 may be configured to determine the target location in response to the navigation request received from the electronic device 528. In some embodiments, the target location may correspond to a location of an entity (such as building point, building equipment etc.) stored within the entity model 524. The target locating module 512 may co-operate with the database 520 to utilize the entity model 524. The target locating module 512 may query the entity model 524 to determine the target location. For example, if a navigation request is received to locate a temperature sensor (target) of the BMS, then the target locating module 512 queries the entity model 524 to determine the location of the temperature sensor in the entity model 524.

Still, referring to FIG. 5, the computing system 500 is shown to include a shortest path determining module 514. The shortest path determining module 514 may be in communication with the user locating module 510 to receive the current location of the user equipped with the electronic device 528. Further, the shortest path determining module 514 may communicate with the target locating module 512 to receive the target location. The shortest path determining module 514 may be configured to determine a shortest navigable path from one or more paths between the current location and the target location.

The shortest path determining module 514 may co-operate with the database 520 to utilize the plurality of markers stored in the building model 522. The shortest path determining module 514 may identify two or more markers between the current location and the target location from the plurality of markers. The shortest path determining module 514 may further determine a distance between the two or more markers. Further, a graph may be generated from the identified two or more markers. In some embodiments, the graph may be an undirected weighted graph having one or more nodes connected by one or more edges. Each node may represent a marker. Further, each edge may connect two adjacent markers from the two or more markers having a walkable path. Each edge may be assigned a weight indicating a distance between the two adjacent markers connecting the edge. In some embodiments, the distance between the two adjacent markers may be obtained from the building model 522. Further, the shortest path determining module 514 may select markers representing the shortest navigable path based on the distance (weight of edges). In some embodiments, one or more shortest path algorithms such as Dijkstra’s graph algorithm, Floyd-Warshall’s method etc. may be applied on the graph to determine the shortest navigable path between the current location and the target location.

Further, the shortest path determining module 514 may co-operate with the database 520 to retrieve spatial anchors 526 associated with the markers representing the shortest navigable path.

Still, referring to FIG. 5, the computing system 500 is shown to include an obstacle detecting module 516. In some embodiments, the obstacle detecting module 516 may co-operate with the database 520 to utilize the plurality of markers stored in the building model 522 for detecting one or more obstacles in a walkable path between the plurality of markers. For example, the one or more obstacles may indicate temporary blocks in the walkable path due to ongoing construction work. The obstacle detecting module 516 may tag one or more markers corresponding to the obstacles. The one or more tagged markers may be disabled and are not selected while determining the shortest navigable path between the current location and the target location. In some embodiments, the one or more markers may be untagged upon determining that the obstacles are eliminated from the walkable path.

Still, referring to FIG. 5, the computing system 500 is shown to include a path navigating module 518. The path navigating module 518 may be in communication with the shortest path determining module 514 and the obstacle detecting module 516. The path navigating module 518 may receive the shortest navigable path (without obstacles), distance of the shortest navigable path and spatial anchors associated with the markers representing the shortest navigable path from the shortest path determining module 514. The path navigating module 518 may interconnect the spatial anchors associated with the markers representing the shortest navigable path. Further, the path navigating module 518 may provide the interconnected spatial anchors to the electronic device 528. The path navigating module 518 may be configured to provide navigation guidance to the electronic device 528 along the shortest navigable path such that the user associated with the electronic device 528 may navigate towards the target location by following the interconnected spatial anchors. As referred above, the electronic device 528 may be facilitated with the mixed reality functionality (for e.g., an application) that may display the hologram of the shortest navigable path superimposed on the camera-derived view in real-time over the electronic device 528. The shortest navigable path may allow the user to easily navigate to the exact target location and may reduce time taken by the user to search for the target location.

Further, in some embodiments, the path navigating module 518 may periodically communicate with the user locating module 510 to receive an updated current location of the user based on movement of the electronic device 528. The path navigating module 518 may update the shortest navigable path based on the updated current location and display the updated shortest navigable path on the electronic device 528.

Additionally, in some embodiments, the shortest navigable path may allow the user to easily navigate to one or more building points that may be hidden or obstructed and thus are difficult to locate for example, building points located inside walls, floors, ceilings etc. In some embodiments, additional information such as status (e.g., active or inactive), attributes, identification (e.g., mac address) of the target building point (target location) may be displayed over the electronic device 528. In some embodiments, additional voice guidance may be provided to the electronic device 528 for the user to commute along the shortest navigable path.

Further, in some embodiments, the path navigating module 518 may be configured to provide an alternate navigable path between the current location and the target location. For example, distance of the alternate navigable path may be longer as compared to the shortest navigable path. However, the alternate navigable path may be selected for display as it may be less time consuming and easier for the user to commute via the alternate navigable path.

Referring now to FIG. 6, the entity model of FIG. 5 is shown, according to some embodiments. The entity model 524 may represent one or more physical, logical and virtual entities of a building. The entity model 524 may store a plurality of entities and location details of each entity. In some embodiments, the entity model 524 may be generated based on the brick schema. Brick schema provides a representation of one or more entities and relationship between the one or more entities. Brick schema defines an ontology for the one or more entities such as building equipment, building points etc. The entity model 524 shows building equipment such as an Air Handling Unit, Variable Air Volume Box, Dampers etc. Further, the entity model 524 shows one or more brick entities such as AHU1A etc. Further, one or more points are shown such as damper position setpoint etc. In addition one or more locations such as Room, HVAC zone etc. are shown.

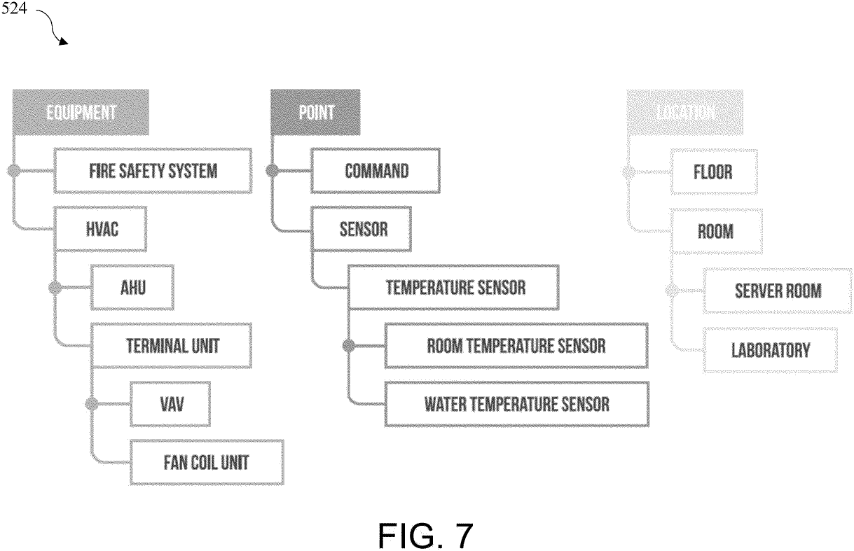

Referring now to FIG. 7, another diagram of the entity model of FIG. 5 is shown, according to an exemplary embodiment. The entity model 524 shows one or more building equipment such as fire safety system, HVAC etc. Further, the entity model 524 shows one or more building points such as commands, sensors etc. Further, one or more locations such as floor, rooms etc. are shown. In some embodiments, the one or more locations may indicate locations of the building equipment, building points etc.

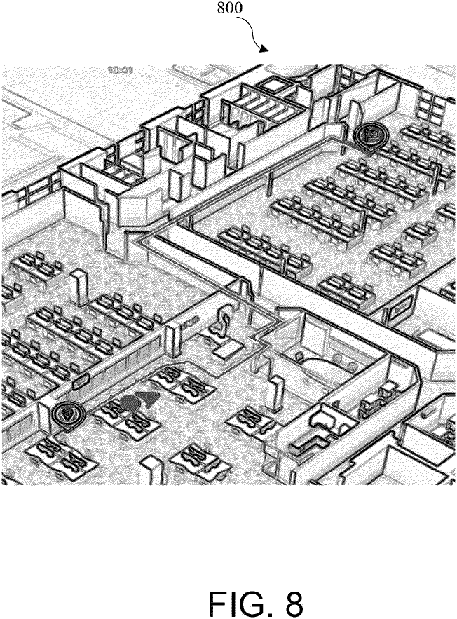

Referring now to FIG. 8, a snapshot of a navigation path computed by the computing system of FIG. 5 is shown, according to an exemplary embodiment. The FIG. 8 illustrates an example 800 showing a hologram of a shortest navigable path between a current location and a target location within a building. The shortest navigable path 800 is displayed over the electronic device 528 to assist the user in navigating to the target location.

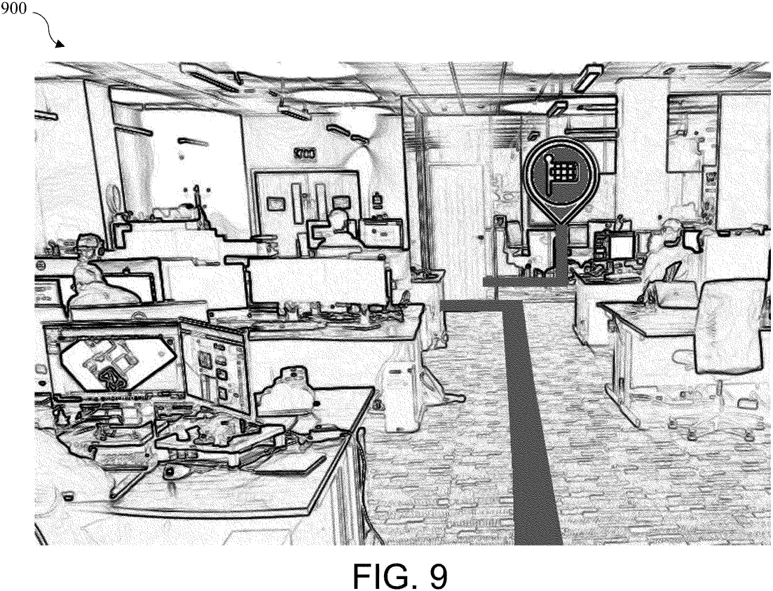

Referring now to FIG. 9, another snapshot of a navigation path computed by the computing system of FIG. 5 is shown, according to an exemplary embodiment. The FIG. 9 illustrates an example 900 showing a hologram of a shortest navigable path between a current location and a target location within a building displayed over the electronic device 528.

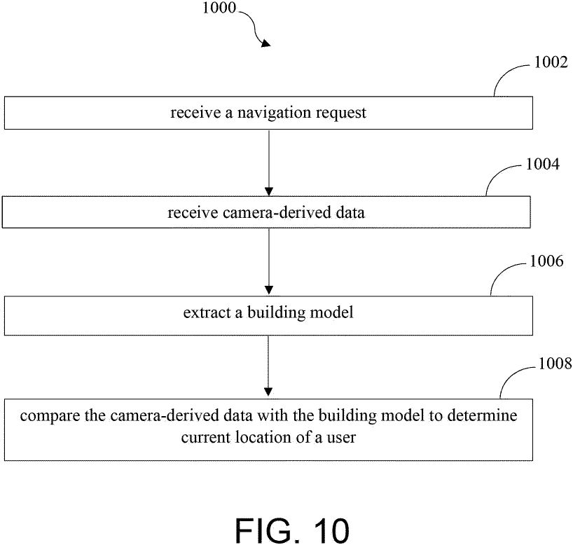

Referring now to FIG. 10, a flow chart of a method 1000 for indoor navigation is shown, according to an exemplary embodiment. In some embodiments, the method 1000 is performed by the computing system 500 referred above in FIG. 5. Alternatively, the method 1000 may be partially or completely performed by another computing system or controller of the BMS. The method 1000 is shown to include receiving a navigation request (Step 1002). In some embodiments, the navigation request may be received from the electronic device 528 in communication with the computing system 500 (referred above in FIG. 5). The navigation request may be generated for obtaining a navigation path to a target location in a building. In some embodiments, the navigation request may be generated through one or more of text based search queries, voice commands, gestures etc.

Further, the method 1000 is shown to include receiving the camera-derived data (Step 1004). The camera-derived data may be received from the electronic device 528 associated with the user. The electronic device 528 may include a camera to generate a camera-derived view of surroundings of the electronic device 528, while the user is maneuvering the electronic device 528 within the building. The camera-derived data may provide scene depth information of surroundings of the electronic device 528. The scene depth information may indicate depth between one or more objects such as walls in the building.

Further, the method 1000 is shown to include extracting the building model 522 (Step 1006). In some embodiments, the building model 522 may be extracted from the database 520 referred above in FIG. 5. The building model 522 may be obtained based on Building Information Modelling (BIM). BIM is a process involving generation and management of digital representations of physical and functional characteristics of a building. In the BIM, a building and its equipment are represented via electronic maps such as 2D maps, 3D maps etc. Further, BIM may generate 3D building models that provide information on various aspects of the building such as floorplan, locations of objects (like building points, building equipment, lights, furniture, doors, windows, stairs, elevators etc.), depth information for objects etc.

Further, the method 1000 is shown to include comparing the camera-derived data with the building model 522 to determine the current location of the user (Step 1008). In some embodiments, the camera-derived data may be compared with the building model 522 by the user locating module 510 (referred above in FIG. 5). In some embodiments, the depth information received from the camera-derived data may be compared with the building model 522. For example, a relative depth between one or more objects such as walls in the building may be compared in the camera-derived data with respect to the building model 522. The current location of the user within the building may be determined based on the comparison of the camera-derived data with the building model 522.

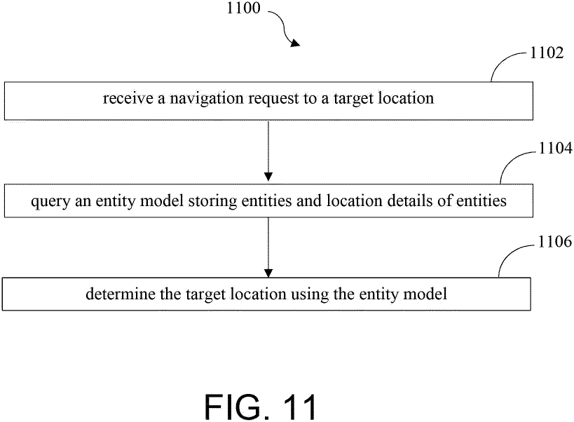

Referring now to FIG. 11, a flow chart of a method 1100 for indoor navigation is shown, according to an exemplary embodiment. In some embodiments, the method 1100 is performed by the computing system 500 referred above in FIG. 5. Alternatively, the method 1100 may be partially or completely performed by another computing system or controller of the BMS. The method 1100 is shown to include receiving a navigation request to reach a target location (Step 1102). In some embodiments, the navigation request may be received from the electronic device 528 in communication with the computing system 500 (referred above in FIG. 5). In some embodiments, the target location may correspond to a location of an entity such as building point, building equipment, etc.

Further, the method 1100 is shown to include querying an entity model 524 (Step 1104). In some embodiments, the entity model 524 may be stored in the database 520 referred above in FIG. 5. In some embodiments, the target locating module 512 may co-operate with the database 520 to query the entity model 524. The entity model 524 may store a plurality of entities and location details of each entity. In some embodiments, the entity model 524 may be alternatively referred as a brick model or brick schema. The brick model (shown in FIG. 6) may provide semantic descriptions of the one or more entities and relationship between the one or more building entities.

Further, the method 1100 is shown to include determining the target location using the entity model 524 (Step 1106). In some embodiments, the target location may be determined by the target locating module 512 by searching the entity model 524. For example, if a navigation request is received to locate a temperature sensor (target) of the BMS, then the target locating module 512 queries the entity model 524 to determine the target location of the temperature sensor in the entity model 524.

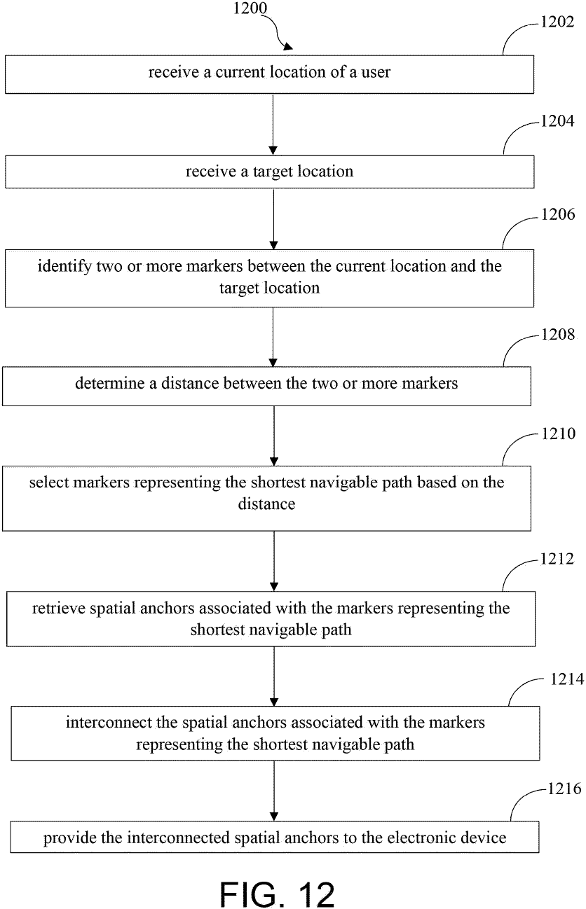

Referring now to FIG. 12, a flow chart of a method 1200 for indoor navigation is shown, according to an exemplary embodiment. In some embodiments, the method 1200 is performed by the computing system 500 referred above in FIG. 5. Alternatively, the method 1200 may be partially or completely performed by another computing system or controller of the BMS. The method 1200 is shown to include receiving a current location of a user (Step 1202). In some embodiments, the current location of the user may be received from the user locating module 510 that compares the scene depth information from the camera-derived data of the electronic device 528 with the building model 522 to determine the current location of the user.

Further, the method 1200 is shown to include receiving the target location (Step 1204). In some embodiments, the target location may correspond to the location of an entity such as building point, building equipment, etc. The target location may be received from the target locating module 512 that queries the entity model 524 to determine the target location.

Further, the method 1200 is shown to include identifying two or more markers between the current location and the target location (Step 1206) from a plurality of markers. The plurality of markers may be stored in the building model 522 of the database 520. Each marker may correspond to an indoor location of a building. In some embodiments, the two or more markers may be determined by the shortest path determining module 514 that co-operates with the database 520 to identify the two or markers between the current location and the target location.

Further, the method 1200 is shown to include determining a distance between the two or more markers (Step 1208). In some embodiments, the distance between the two or more markers may be determined by the shortest path determining module 514. Further, a graph may be generated from the identified two or more markers. In some embodiments, the graph may be an undirected weighted graph having one or more nodes connected by one or more edges. Each node may represent a marker. Further, each edge may connect two adjacent markers from the two or more markers having a walkable path. Each edge may be assigned a weight indicating a distance between the two adjacent markers connecting the edge. In some embodiments, the distance between the two adjacent markers may be obtained from the building model 522.

Further, the method 1200 is shown to include selecting markers representing the shortest navigable path (Step 1210). The shortest path determining module 514 may select markers representing the shortest navigable path based on the distance (weight of edges). In some embodiments, one or more shortest path algorithms such as Dijkstra’s graph algorithm, Floyd-Warshall’s method etc. may be applied on the graph to determine the shortest navigable path between the current location and the target location.

The method 1200 is further shown to include retrieving spatial anchors associated with the markers representing the shortest navigable path (Step 1212). In some embodiments, the plurality of spatial anchors 526 may be stored in the database 520 referred above in FIG. 5. The spatial anchors 526 may comprise information such as location details of the spatial anchors, depth of the spatial anchors etc. In some embodiments, the spatial anchors 526 may be placed in the building such that a walkable path is provided between two adjacent spatial anchors from the one or more spatial anchors. In some embodiments, the spatial anchors 526 may be placed at prime locations for example at an entrance point and an exit point of a building, floors, rooms etc. In some embodiments, the spatial anchors 526 may be placed at walkway ends or corners of a building. Further, each spatial anchor may be associated with a marker such that a one-on-one correspondence is established between the spatial anchors 526 and the markers.

Further, spatial anchors associated with the markers representing the shortest navigable path between the current location and the target location may be retrieved. In some embodiments, one or more obstacles in a walkable path between the plurality of markers may be detected by the obstacle detecting module 516. For example, the one or more obstacles may indicate temporary blocks in the walkable path due to ongoing construction work. Further, one or more markers corresponding to the obstacles may be tagged. The one or more tagged markers may be disabled and are not selected while determining the shortest path between the current location and the target location.

Further, the method 1200 is shown to include interconnecting the spatial anchors associated with the markers representing the shortest navigable path (Step 1214). In some embodiments, the path navigating module 518 may communicate with the shortest path determining module 514 to receive the spatial anchors associated with the markers representing the shortest navigable path and further interconnect the spatial anchors.

Further, the method 1200 is shown to include providing the interconnected spatial anchors associated with the markers representing the shortest navigable path to the electronic device 528 (Step 1216). In some embodiments, the interconnected spatial anchors may be provided to the electronic device 528 by the path navigating module 518. The path navigating module 518 may provide navigation guidance to the electronic device 528 along the shortest navigable path such that the user associated with the electronic device 528 may navigate towards the target location by following the interconnected spatial anchors. As referred above, the electronic device 528 may be facilitated with the mixed reality functionality (for e.g., an application) that may display the hologram of the shortest navigable path connecting the spatial anchors superimposed on the camera-derived view in real-time over the electronic device 528. The shortest navigable path may allow the user to easily navigate to the exact target location and may reduce time taken by the user to search for the target location.

In some embodiments, an updated shortest navigable path may be displayed on the electronic device 528 based on the updated current location of the user received from the user locating module 510.

Additionally, in some embodiments, the shortest navigable path may allow the user to easily navigate to one or more building points that may be hidden or obstructed and thus are difficult to locate for example, building points located inside walls, floors, ceilings etc. In some embodiments, additional information such as status (e.g., active or inactive), attributes, identification (e.g., mac address) of the target building point (target location) may be displayed over the electronic device 528. In some embodiments, additional voice guidance may be provided to the electronic device 528 for the user to commute along the shortest navigable path.

### Configuration of Exemplary Embodiments

The construction and arrangement of the systems and methods as shown in the various exemplary embodiments are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.). For example, the position of elements can be reversed or otherwise varied and the nature or number of discrete elements or positions can be altered or varied. Accordingly, all such modifications are intended to be included within the scope of the present disclosure. The order or sequence of any process or method steps can be varied or re-sequenced according to alternative embodiments. Other substitutions, modifications, changes, and omissions can be made in the design, operating conditions and arrangement of the exemplary embodiments without departing from the scope of the present disclosure.

The present disclosure contemplates methods, systems and program products on any machine-readable media for accomplishing various operations. The embodiments of the present disclosure can be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures show a specific order of method steps, the order of the steps may differ from what is depicted. Also two or more steps can be performed concurrently or with partial concurrence. Such variation will depend on the software and hardware systems chosen and on designer choice. All such variations are within the scope of the disclosure. Likewise, software implementations could be accomplished with standard programming techniques with rule based logic and other logic to accomplish the various connection steps, processing steps, comparison steps and decision steps.

What is claimed is:

1. A building management system (BMS), comprising:
one or more non-transitory computer-readable storage media storing instructions that, when executed by one or more processors, cause the one or more processors to perform operations comprising:
receiving a target location from an electronic device associated with a user;
determining a current location of the user;
determining a shortest navigable path from the current location to the target location; and
identifying one or more spatial anchors associated with the shortest navigable path.

2. The system of claim 1, wherein the operations further comprise providing information regarding the one or more identified spatial anchors to the electronic device to guide the user from the current location to the target location.

3. The system of claim 1, wherein the one or more non-transitory computer-readable storage media comprise a database including:
a list of spatial anchors including the one or more identified spatial anchors; and
a building model having a plurality of markers, wherein each marker represents an indoor location associated with one of the one or more spatial anchors.

4. The system of claim 3, wherein the operations further comprise identifying the current location of the user by comparing the camera-derived data with the building model.

5. The system of claim 3, wherein the database further comprises an entity model having a plurality of entities and a location of each entity.

6. The system of claim 5, wherein the target location corresponds to a location of one of the plurality of entities.

7. The system of claim 3, wherein determining the shortest navigable path from the current location to the target location comprises:
determining a distance between each of one or more pairs of markers using the building model;
determining the shortest navigable path based on the one or more determined distances; and
retrieving spatial anchors associated with markers representing the shortest navigable path.

8. The system of claim 7, wherein the operations further comprise:
interconnecting the spatial anchors associated with the markers representing the shortest navigable path;
receiving, from the electronic device, a video feed from a camera associated with the electronic device;
generating a combined video feed including a graphical representation of the shortest navigable path superimposed on the video feed from the camera; and
providing the combined video feed to the electronic device.

9. The system of claim 8, wherein the graphical representation of the shortest navigable path includes a visible navigation path connecting the spatial anchors associated with the markers representing the shortest navigable path.

10. The system of claim 7, wherein the operations further comprise:
receiving an indication of one or more obstacles;
determining and tagging one or more markers associated with spatial anchors proximate the one or more obstacles; and
excluding the one or more tagged markers from the determination of the shortest navigable path.

11. The system of claim 7, wherein the operations further comprise:
interconnecting the spatial anchors associated with the markers representing the shortest navigable path;
receiving, from the electronic device, a video feed from a camera associated with the electronic device;
generating a graphical representation of the shortest navigable path based on the video feed from the camera; and
providing the graphical representation to the electronic device for display on a transparent surface, wherein the graphical representation is superimposed on a real-world view that is visible through the transparent surface.

12. The system of claim 1, wherein the operations further comprise receiving camera-derived data, wherein the current location of the user is determined based on the camera-derived data.

13. A method for determining a path in a building, the method comprising:
receiving a video feed of the building from an electronic device associated with a user;
comparing depth data from the video feed with stored depth data from a building model associated with the building;
determining a current location of the user within the building based on the comparison;
receiving a target location within the building from the electronic device; and
determining a path from the current location to the target location by identifying and connecting one or more markers representing an indoor location of the building.

14. The method of claim 13, wherein the one or more markers each correspond to a spatial anchor located in the building.

15. The method of claim 14, further comprising
identifying, in the video feed, the spatial anchors corresponding to the one or more markers;
generating a combined video feed including a graphical representation of the path superimposed on the video feed from the electronic device, the graphical representation of the path connecting the identified spatial anchors in the video feed; and
providing the combined video feed to the electronic device.

16. The method of claim 14, further comprising
receiving an indication of an obstacle in the building;
determining one or more spatial anchors proximate the obstacle; and
tagging one or more markers associated with the one or more spatial anchors proximate the obstacle, wherein the determined path avoids the tagged markers.

17. The method of claim 13, wherein the path is one of a shortest navigable path or an alternate navigational path determined based on a user selection received from the electronic device.

18. One or more non-transitory computer-readable storage media storing instructions that, when executed by one or more processors, cause the one or more processors to perform operations comprising:
receiving a desired destination from an electronic device associated with a user;
determining a current location of the user;
determining a shortest navigable path from the current location to the desired destination; and
identifying a plurality of spatial anchors that can be connected to form the shortest navigable path.

19. The one or more non-transitory computer-readable storage media of claim 18, wherein determining a shortest navigable path from the current location to the desired destination comprises:
querying a database of markers, wherein each marker is associated with a location of one of the spatial anchors;
determining a distance between each of one or more pairs of markers; and
determining the shortest navigable path based on the one or more determined distances.

20. The one or more non-transitory computer-readable storage media of claim 18, wherein the operations further comprise:
detecting spatial anchors in the video feed;
generating a combined video feed including a graphical representation of the shortest navigable path superimposed on the video feed from the electronic device, wherein the graphical representation of the shortest navigable path connects two or more of the detected spatial anchors; and
providing the combined video feed to the electronic device.
